(19) United States
(12) Patent Application Publication
(10) Pub. No.: US 2009/0238088 A1
(43) Pub. Date: Sep. 24, 2009

(54) NETWORK TRAFFIC ANALYZING DEVICE, NETWORK TRAFFIC ANALYZING METHOD AND NETWORK TRAFFIC ANALYZING SYSTEM

(75) Inventor: Joohwa TAN, Saitama (JP)

Correspondence Address: POSZ LAW GROUP, PLC, 12040 SOUTH LAKES DRIVE, SUITE 101, RESTON, VA, 20191, US

(73) Assignee: OKI ELECTRIC INDUSTRY CO., LTD., Tokyo (JP)

(21) Appl. No.: 12/355,089

(22) Filed: Jan. 16, 2009

(30) Foreign Application Priority Data
Mar. 19, 2008 (JP) 2008-071208

(51) Int. Cl. G06F 11/30

(52) U.S. Cl. 370/252

(57) ABSTRACT

A network traffic analyzing device accurately analyzes traffic of a communications network. The traffic analysis device includes a real time monitoring unit configured to collect information regarding communication data between a primary network and an access network from a traffic collecting device in real time; an alert managing/notifying unit that generates an alert regarding traffic between the primary network and the access network based on the information collected in real time by the traffic collecting device; and an alert generation cause analyzing unit that analyzes a cause of the alert generated by the alert managing/notifying unit based on information regarding at least one of normal data and abnormal data transmitted and received between the primary network and the access network prior to generation of the alert by the alert managing/notifying unit.

### CROSS REFERENCE TO RELATED APPLICATION

The present application is related to, claims priority firm and incorporates by reference Japanese Patent Application No. JP 2008-071208, filed on Mar. 19, 2008. This application is also related to co-pending application Ser. No. ______ (attorney docket no. 98A-001) filed concurrently herewith and entitled NETWORK TRAFFIC ANALYZING DEVICE, NETWORK TRAFFIC ANALYZING METHOD AND NETWORK TRAFFIC ANALYZING SYSTEM.

### TECHNICAL FIELD

The invention relates to communications networks, and more particularly to a network traffic analyzing device, method and system.

### BACKGROUND

In a known method of analyzing communications network packet traffic, a network traffic collecting device collects network traffic information and a specialist analyzes the information. In another known method, a network traffic collecting device collects packet information in its transmitted format and converts it into a counter table or a graph (waveform) and a network manager analyzes the information based on the table or graph.

However, when a network traffic problem occurs, the manager in charge of analyzing the information must try to collect the network traffic information using a manual operation in order to determine the source or cause of the problem. When the information is or can not be collected, it is necessary to determine the source or cause of the problem from the limited information that is available to resolve the problem. Even when the information can be collected, it is necessary to analyze a large amount of information to determine and resolve the source or cause of the problem.

Particularly, since most network traffic problems occur within a short time, or momentarily and repeatedly at unpredictable irregular times, it is difficult to gather the information necessary to analyze a problem. For this reason, it may be difficult to identify and clear up the cause of a network traffic problem. Therefore, it is difficult to quickly solve such problems.

To identify unpredictable network traffic problems when they occur, a device may be implemented that always monitors all traffic packets and stores the monitored traffic packets in their transmitted form.

However, when the packets are stored in their transmitted form, a certain amount of device memory must be used for a short period of time. Accordingly, it is difficult to store the packets. In addition, since the stored packets are periodically replaced by newly acquired packets to be analyzed, the stored packets may disappear. Accordingly, it is difficult to store desired information for analysis. For this reason, there is a problem that a long time is necessary to identify and clear up the cause of a network traffic problem.

In a second case where codec conversion is performed in a boundary between business networks, there are problems such as: (a) plural kinds of codec conversion are not supported; (b) there is no countermeasure against simultaneous processing of plural channels; and (c) conversion process delay is not considered.

Because it is easy to place a codec conversion function corresponding to a case of communicating with two terminals in a small-scale gateway device, the aforementioned problems (a) to (c) occur.

There are many kinds of business networks relating to Internet Protocol (IP) interconnections (in other words, there are many kinds of codecs). Accordingly, when plural kinds of codec conversions are not supported, a gateway device needs to be provided for each kind of codec conversion being utilized. Therefore, a traffic analysis system may become complicated and large.

For IP interconnections, it is very preferable that there are a large number of channels between business networks and that there are a large number of channels corresponding to one codec conversion device.

Since real time communication is important even in UP interconnections, media transmission delay including codec conversion processing time must be minimized. In many systems, target end-to-end delay between respective business network terminals for audio communication is within 100 ms (target delay of video communication is within 200 ms). The target delay has a value that enables a network user to naturally converse or otherwise communicate over the network without having the delay be subjectively noticeable. When the delay exceeds the target delay, the user may not be able to comfortably hold a conversation over the network due to the delay.

Although network communications problems information has been described above with respect to audio transmission, the same problems exist with respect to video data transmission.

For this reason, it is desired to provide a codec conversion device, a gateway device, and a codec conversion method that can cope with the simultaneous processing of plural communications network channels in addition to the plural kinds of codec conversions and that have low codec conversion processing delays.

### SUMMARY

In view of the above, a novel and improved network traffic analyzing device, method and system are provided that reliably detect and analyze network traffic problems with high precision. To solve the aforementioned problems, according to one exemplary embodiment, a network traffic analyzing device for analyzing traffic includes: a real time monitoring unit configured to collect information regarding communication data between the primary network and the access network from a traffic collecting device in real time; an alert managing/notifying unit configured to generate an alert regarding traffic between the primary network and the access network based on the information collected in real time by the traffic collecting device; and an alert generation cause analyzing unit configured to analyze a cause of the alert generated by the alert managing/notifying unit based on information regarding at least one of normal data and abnormal data transmitted and received between the primary network and the access network prior to generation of the alert by the alert managing/notifying unit.

With such a configuration, the information regarding the communication data between the primary network and the access network is collected in real time from the traffic collecting device, the alert regarding the traffic between the network and the access network is generated based on the information collected in real time from the traffic collecting device, and the cause of the alert generation is analyzed based on information regarding at least one of the normal data and the abnormal data transmitted and received between the network and the access network just before the alert is generated. Accordingly, it is possible to reliably analyze the cause of the alert generation based on at least one of the normal data and the abnormal data just before the alert is generated.

To solve the aforementioned problems, according to another aspect of the invention, there is provided a method of analyzing network traffic including: collecting information regarding communication data between a primary network and an access network from a traffic collecting device in real time; generating an alert regarding traffic between the primary network and the access network based on the information collected in real time from the traffic collecting device; and analyzing a cause of the alert generation based on information on at least one of normal data and abnormal data transmitted and received between the primary network and the access network just before the alert is generated.

With such a configuration, the information regarding the communication data between the network and the access network is collected in real time from the traffic collecting device, the alert regarding the traffic between the network and the access network is generated based on the information collected in real time from the traffic collecting device, and the cause of the alert generation is analyzed based on the information regarding at least one of the normal data and the abnormal data transmitted and received between the network and the access network just before the alert is generated. Therefore, it is possible to reliably analyze the cause of the alert generation based on at least one of the normal data and the abnormal data just before the alert is generated.

According to another exemplary embodiment, a network traffic analyzing system includes: a traffic collecting device for collecting information on abnormal traffic from an access network connected to a primary network; a network traffic analyzing device for analyzing the collected traffic information; and a monitoring device connected to the traffic collecting device for monitoring and storing information on normal traffic. The network traffic analyzing device includes a real time monitoring unit configured to collect information regarding communication data between the primary network and the access network in real time from the traffic collecting device, an alert managing/notifying unit configured to generate an alert regarding traffic between the primary network and the access network based on the information collected in real time from the traffic collecting device, and an alert generation cause analyzing unit configured to analyze the cause of the alert generation based on information regarding at least one of normal data and abnormal data transmitted and received between the primary network and the access network just before the alert is generated.

With such a configuration, the network traffic analyzing system includes the traffic collecting device for collecting the traffic information from the access network connected to the network, the network traffic analyzing device for analyzing the traffic information, and the monitoring device connected to the traffic collecting device. In the network traffic analyzing device, the information regarding the communication data between the network and the access network is collected in real time from the traffic collecting device, the alert regarding the traffic between the network and the access network is generated based on the information collected in real time from the traffic collecting device, and the cause of the alert generation is analyzed based on the information regarding at least one of the normal data and the abnormal data transmitted and received between the network and the access network just before the alert is generated. Therefore, it is possible to reliably analyze the cause of the alert generation based on at least one of the normal data and the abnormal data just before the alert is generated.

According to the exemplary embodiments, it is possible to provide the network traffic analyzing device (or traffic analyzing device), and the network traffic analyzing method (traffic analyzing method), and the network traffic analyzing system (or traffic analyzing system) capable of reliably analyzing the traffic of the network with high precision and reliably analyzing the cause of the alert generation.

### BRIEF DESCRIPTION OF THE DRAWINGS

FIG. 1 is a schematic diagram illustrating a traffic collecting device according to a first exemplary embodiment in a communications network.

FIG. 2A is a schematic diagram illustrating functions of the monitoring device of FIG. 1; and FIG. 2B is a schematic diagram illustrating a configuration of the monitoring device.

FIG. 3A is a schematic diagram illustrating functions of the traffic collecting device of FIG. 1; and FIG. 3B is a schematic diagram illustrating a configuration of the traffic collecting device.

FIG. 4 is a schematic diagram illustrating a configuration of the ingress packet filter unit and the egress packet filter unit of the traffic collecting device of FIG. 3B.

FIG. 5 is a schematic diagram illustrating a configuration of the abnormal traffic detecting unit of the traffic collecting device of FIG. 3B.

FIG. 6 is a flow diagram illustrating processes of the session processing unit of FIG. 5.

FIG. 7 is a schematic diagram illustrating functions of the traffic analyzing device of FIG. 1.

FIG. 8 is a schematic diagram illustrating a configuration of the traffic analyzing device shown in FIG. 7.

FIG. 9 is a schematic diagram illustrating a functional configuration of the integrated management device of FIG. 1.

FIG. 10 is a schematic diagram illustrating a configuration of the real time statistic information setting/managing unit (part I) of FIG. 8.

FIG. 11 is a schematic diagram illustrating a configuration of the real time statistic information setting/managing unit (part II) of FIG. 8.

FIG. 12 is a schematic diagram illustrating processes of the real time statistic information monitoring unit of FIG. 8.

FIG. 13 is a schematic diagram illustrating settings performed in the alert condition setting unit of FIG. 8.

FIG. 14 is a flow diagram illustrating processes of the alert managing/notifying unit of FIG. 8.

FIG. 15 is a schematic diagram illustrating processes performed in the real time monitor alert generation cause identifying/analyzing unit of FIG. 8 to identify an upper limit excess cause.

FIG. 16 is a schematic diagram illustrating the processes shown in FIG. 15 in more detail.

### DETAILED DESCRIPTION

Hereinafter, a preferred embodiment of the invention will be described in detail with reference to the accompanying drawings.

In the specification and the drawings, the same reference numerals are given to all elements having substantially the same configuration, and corresponding redundant description is omitted.

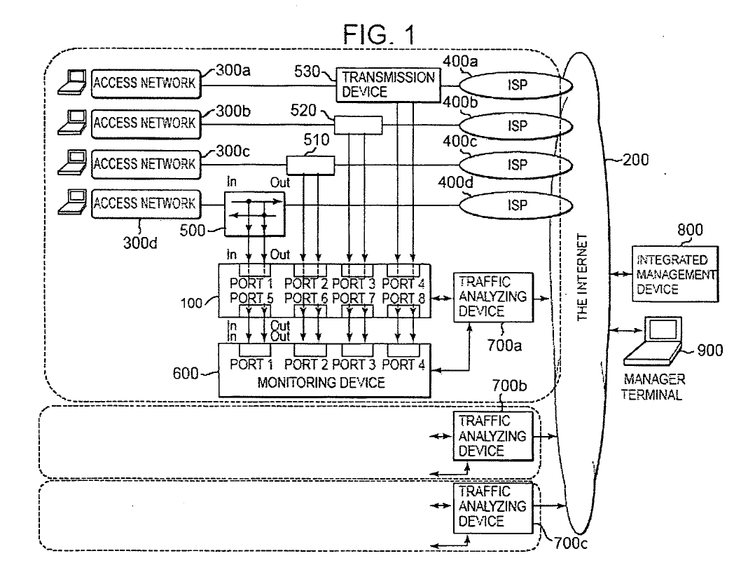

Referring to FIG. 1, a first exemplary embodiment will be described. Specifically, a traffic collecting device 100, which is installed in order to connect to a communications network (referred to hereafter as a primary network) 200, which is depicted in FIG. 1 as the Internet, is shown. Transmission devices (network tap devices) 500, 510, 520, and 530 dividing and outputting communication signals are respectively disposed at lines between access networks 300a, 300b, 300c, 300d and Internet Services Providers (ISPs) 400a, 400b, 400c, 400d. The divided output lines of input (In) side (the side on which access networks 300a-300d are located) and output (Out) side (the side on which ISPs 400a-400d are located) of each of the transmission devices 500, 510, 520, and 530 are respectively connected to the In sides and Out sides on the line side of the traffic collecting device (also referred to as the traffic collecting device) 100. Similarly, the output lines the traffic collecting device 100 at its monitor side are connected to a monitoring device 600. In the example shown in FIG. 1, it is assumed that the monitoring device 600 is a device that can be installed independently in an in-line manner.

As shown in FIG. 1, a traffic analyzing device 700a (or network traffic analyzing device) for analyzing traffic is connected to the traffic collecting device 100 and the monitoring device 600.

Traffic information, which is alternatively referred to as traffic data, on the lines between the access networks 300a-300d and the ISPs 400a-400d is respectively collected by the transmission devices 500-530 and the traffic collecting device 100. The traffic analyzing device 700a automatically analyzes the traffic information collected from the lines, extracts data related to the importance of the analysis results, and creates an analysis report. The traffic analyzing device 700a regularly collects the traffic information at a preset interval, monitors the traffic, displays a table and a graph of the collected information in real time, and creates a regular report or an analysis report.

Further, a traffic analyzing device 700b (or network traffic analyzing device) and a traffic analyzing device 700c (or network traffic analyzing device) analyze information collected by respective traffic collecting devices through respective transmission devices disposed at lines between other access networks and ISPs in a similar manner. However, for simplicity of explanation, only a detailed description of the structure and operation of the traffic analyzing device 700a is provided.

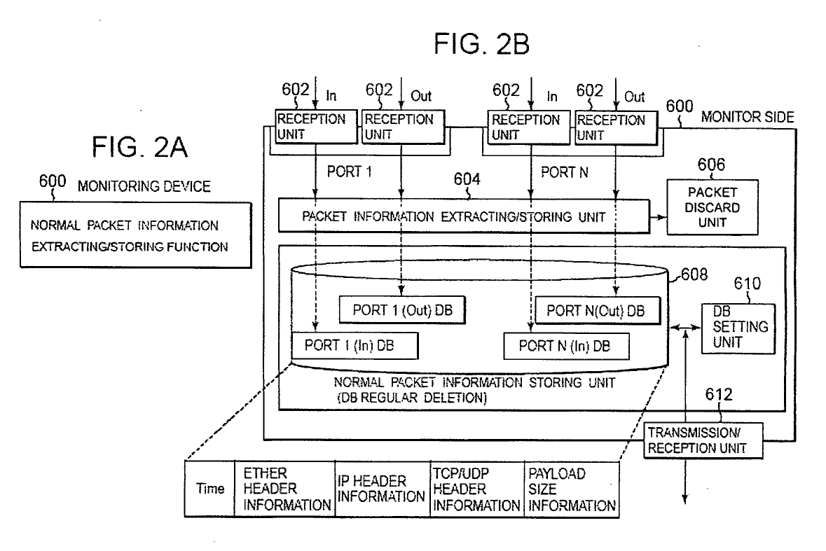

FIGS. 2A and 2B are a schematic diagram illustrating the functionality of the monitoring device 600 and a configuration for realizing the functions, respectively. As shown in FIG. 2A, the monitoring device 600 has a function for extracting/storing normal packet information. In order to store packet information from more packets, the monitoring device 600 extracts only information such as the packet header without storing whole data of normal packets input to the monitoring device 600 through the traffic collecting device 100, and stores the information in a database of a normal packet information storing unit 608.

In FIG. 2B, a reception unit 602 separately receives inputs of the In side and Out side from the traffic collecting device 100. A packet information extracting/storing unit 604 extracts packet information or data form the packet data received by the reception unit 602 and stores the packet information. Unnecessary packets are discarded in a packet discard unit 606.

The normal packet information storing unit 608 stores normal packet information for each of ports 1 to N of the traffic collecting device 100. The normal packet information includes time information (time), ether header information, IP header information, TCP/UDP header information, and payload size information. The information stored in the database of the normal packet information storing unit 608 is periodically deleted. The monitoring device 600 has a database (DB) setting unit 610 for setting a database of the normal packet information storing unit 608, and a transmission/reception unit 612. The transmission/reception unit 612 is connected to the traffic analyzing device 700a. When an alert is generated, the monitoring device 600 receives normal packet information necessary for alert generation caused by identification analysis from the database of the normal packet information storing unit 608, according to a request of the traffic analyzing device 700a received through the transmission/reception unit 612, and the monitoring device 600 transmits the information to the traffic analyzing device 700a through the transmission/reception unit 612.

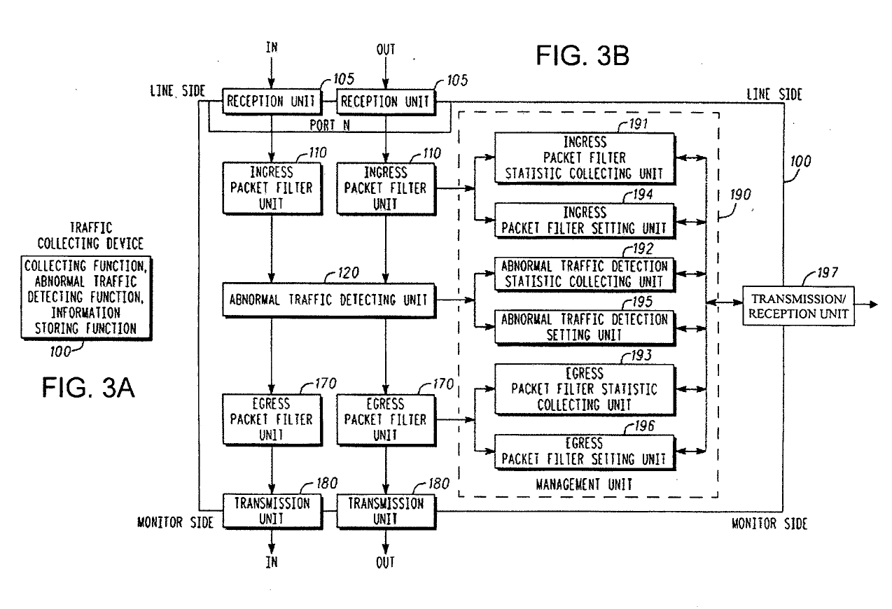

As shown in FIG. 3A, the traffic collecting device 100 has a collection function, an abnormal traffic detecting function, and an information storing function. FIG. 3B is a functional schematic diagram of the traffic collecting device 100. The traffic collecting device 100 includes a reception unit 105, an input (Ingress) packet filter unit 110, an abnormal traffic detecting unit 120, an output (Egress) packet filter unit 170, a transmission unit 180 and a management unit 190. The input (Ingress) packet filter unit 110 extracts and searches identifiers of an ether header, an IP header, and a TCP/UDP header of packets from each of the transmission devices 500, 510, 520, and 530 of the line side, and the Ingress packet filter unit 110 performs filtering based on the identifiers. The reception unit 105 separately receives inputs of In sides and Out sides from the transmission devices 500, 510, 520, and 530. The input (Ingress) packet filter unit 110 extracts and searches identifiers of an ether header, an IP header, and a TCP/UDP header of packets from each of the transmission devices 500, 510, 520, and 530 of the line side, and the Ingress packet filter unit 110 performs filtering based on the identifiers.

The abnormal traffic detecting unit 120 processes packets from both the In sides and the Out sides passing through the Ingress packet filter unit 110, thereby recognizing the packets as sessions.

The output (Egress) packet filter unit 170 can perform filtering on packets based on the identifier of the header as well as the Ingress packet filter unit 110. The packets passing through Egress packet filter unit 170 are transmitted from the transmission unit 180 of the monitor side.

The management unit 190 includes a statistic collecting unit 191 of the Ingress packet filter unit 110 (Ingress packet filter statistic collecting unit), a statistic collecting unit 192 of the abnormal traffic detecting unit 120 (abnormal traffic detection statistic collecting unit), a statistic collecting unit 193 of the Egress packet filter unit 170 (Egress packet filter statistic collecting unit), a setting unit 194 of the Ingress packet filter unit 110 (Ingress packet filter setting unit), a setting unit 195 of the abnormal traffic detecting unit 120 (abnormal traffic detection setting unit), and a setting unit 196 of the Egress packet filter unit 170 (Egress packet filter setting unit).

The management unit 190 is connected to the traffic analyzing device 700a through a transmission/reception unit 197, and serves as an interface of statistic information and setting information for communicating with the traffic analyzing device 700a.

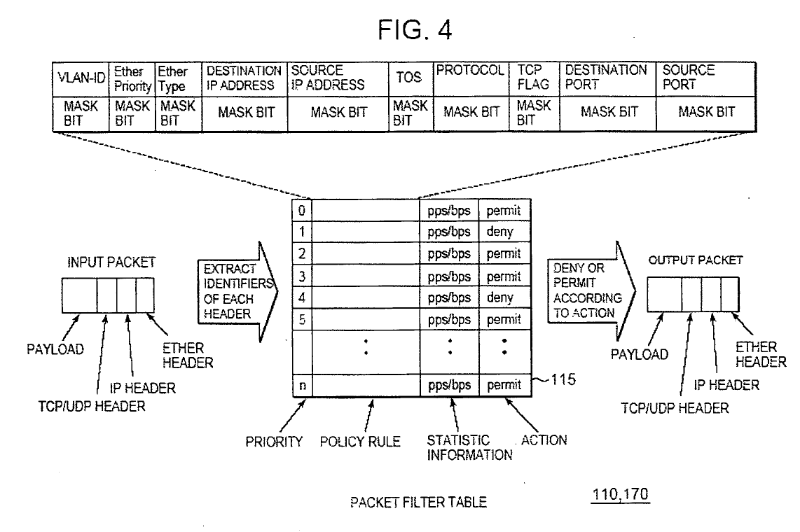

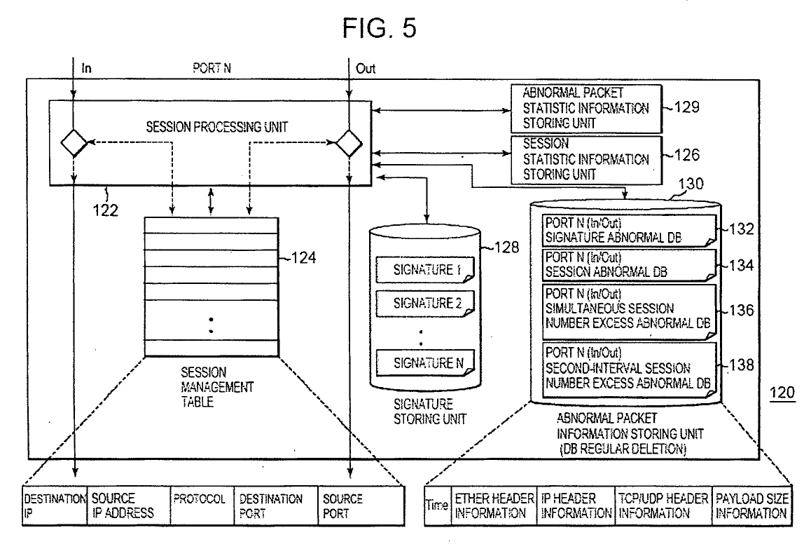

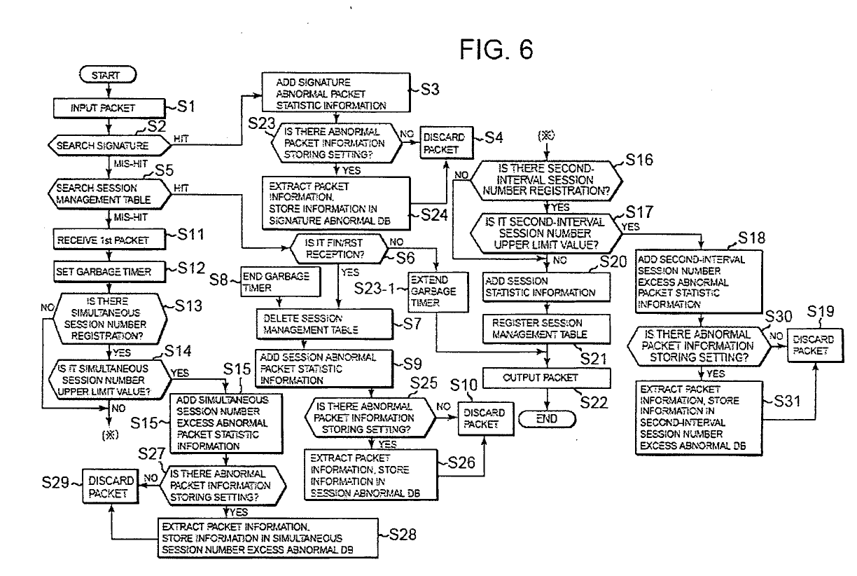

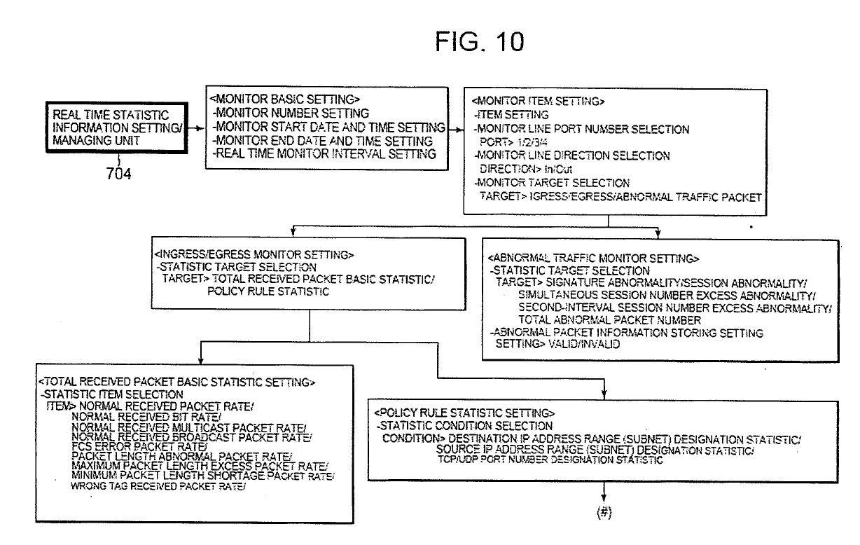

Hereinafter, a configuration of the Ingress and Egress packet filter units 110, 170 of the traffic collecting device 100, a configuration of the abnormal traffic detecting unit 120, and a flow of session processes will be described with reference to FIG. 4, FIG. 5, and FIG. 6. Based on such information and conditions, a real time statistic information setting/managing unit 704 shown in FIG. 10 is designed.

FIG. 4 shows a configuration the Ingress packet filter unit 110 and the Egress packet filter unit 170. The packet filter units 110, 170 include a packet filter table 115. As the identifiers of the ether header, the IP header, and the TCP/UDP header that can be set by a policy rule, a VLAN-ID, an ether priority, an ether type, a destination IP address, a source IP address, a TOS, a protocol number, a TCP flag, a destination port number, and a source port number are listed as shown in FIG. 4. In each identifier, a mask bit is designated so that a range-search can be performed.

In the packet filter table 115, a priority is assigned to each entry. In the example shown in FIG. 4, a small number has high priority. As a result of searching identifiers, an entry that is hit during searching with higher priority is employed, and “permit” or “deny” is selected according to an action (permit or deny) corresponding to each entry that is preset. The packet filter table 115 has a packet counter (pps) and a byte counter (bps) as statistic information for each entry. The packet counter and the byte counter are incremented by all entries that were hit as a result of the search.

FIG. 5 is a schematic diagram illustrating a configuration of the abnormal traffic detecting unit 120. The abnormal traffic detecting unit 120 includes a session processing unit 122, a session management table 124, a session statistic information storing unit 126, a signature storing unit 128 and an abnormal packet statistic information storing unit 129. Both packets of the In line side and the Out line side input to the abnormal traffic detecting unit 120 are input to the session processing unit 122, and are processed according to the flow diagram of the session process shown in FIG. 6. The abnormal traffic detecting unit 120 has an abnormal packet information storing unit 130. The abnormal packet information storing unit 130 includes a signature abnormal database (DB) 132 of a port N (In/Out), a session abnormal database (DB) 134 of a port N (In/Out), a simultaneous session number excess abnormal database (DB) 136 of a port N (In/Out), and a second-interval session number excess abnormal database (DB) 138 of a port N (In/Out). In the databases, time, ether header information, IP header information, TCP/UDP header information, and payload size information are stored as information for abnormal packets.

Hereinafter, the session process of the traffic collecting device 100 will be described with reference to FIGS. 5 and 6. At S1, a packet is input to the session processing unit 122. At S2, a signature is searched. Signatures registered in the signature storing unit 128 each describe a pattern that is an abnormal packet such as, for example, a pattern that the destination IP address is the same as the source IP address, the source IP address is false, or an IP packet exceeds the maximum length when the IP packet is rebuilt with a destination host. When a signature is hit, the process proceeds to S3. At S3, signature abnormal packet statistic information is added, and the process proceeds to S23. At S23, it is determined whether or not there is a storing setting of abnormal packet information. When there is a storing setting of abnormal packet information, packet information is extracted at S24 and is stored in the signature abnormal database 130, and then the packet is discarded at S4. When there is no storing setting of abnormal packet information at S23, the packet is discarded at 84.

When the signature is mis-hit, meaning that the signature is not found during searching, at S2, the process proceeds to S5 and then a session management table is searched. When the packet is hit in the session management table, the process proceeds to S6 and then it is determined whether or not FIN/RST is received. When the FIN/RST is received at S6, the process proceeds to S7 and the session management table is deleted by receiving the end of a garbage timer of S8. Then, at S9, session abnormal packet statistic information is added. After S9, the process proceeds to S25 and it is determined whether or not there is a storing setting of abnormal packet information. When there is a storing setting of abnormal packet information, packet information is extracted at S26 and is stored in the session abnormal database 134, and then the packet is discarded at S10. When there is no storing setting of abnormal packet information at S25, the packet is discarded at S10. When the FIN/RST is not received at S6, the process proceeds to S23-1 and the garbage timer is extended. Then, the packet in sequence is processed/output under the current session management table.

When the session management table is mis-hit, meaning that the signature is not found during searching, at S5, the process proceeds to S11 and the first packet (1st packet) is received. At S12, the garbage timer is set. At S13, it is determined whether or not there is registration of the simultaneous session number.

When there is registration of the simultaneous session number at S13, the process proceeds to S14 and then it is determined whether or not the simultaneous session number is an upper limit value. When the simultaneous session number is the upper limit value at S14, the statistic information of the abnormal packet having the simultaneous session number exceeding the upper limit value at S15 is added. After S15, the process proceeds to S27 and it is determined whether or not there is a storing setting of abnormal packet information. When there is a storing setting of abnormal packet information, packet information is extracted at S28 and stored in the simultaneous session number excess abnormal database 136, and then the packet is discarded at S29. When there is no storing setting of abnormal packet information at S27, the packet is discarded at S29. When the simultaneous session number is not the upper limit value at S14, or when there is no registration of the simultaneous session number at S13, the process proceeds to S16.

At S16, it is determined whether or not there is registration of a second-interval session number. When there is registration of a second-interval session number, it is determined whether or not the second-interval session number is an upper limit value at S17. When the second-interval session number is the upper limit value at S17, statistic information of the packet having the second-interval session number exceeding the upper limit value at S18 is added. After S18, the process proceeds to S30 and it is determined whether or not there is a storing setting of abnormal packet information. When there is a storing setting of abnormal packet information, packet information is extracted at S31 and stored in the second-interval session number excess abnormal database 138, and then the packet is discarded at S19. When there is no stoning setting of abnormal packet information at S30, the packet is discarded at S19. When the second-interval session number is not the upper limit value at 817, or when there is no registration of the second-interval session number at S16, the process proceeds to S20.

At S20, session statistic information is added. At S21, the session management table is registered. At S22, the packet is output. After S22, the process ends (END).

The session processed in the session processing unit 122 is registered in the session management table 124. In this case, registered identifiers are five identifiers (destination IP address, source IP address, protocol number, destination port number, and source port number) shown in FIG. 5. The session statistic information storing unit 126 stores the session number registered in the session management table 124 by each combined unit of the destination IP address and the source IP address.

At S2 shown in FIG. 6, the packet input to the abnormal traffic detecting unit 120 is compared with each signature registered in the signature storing unit 128, and it is determined whether or not the packet is an abnormal packet. As discussed previously the signature registered in the signature storing unit 128 describes a pattern that is an abnormal packet such as, for example, a pattern that the destination IP address is the same as the source IP address, the source IP address is false, or an IP packet exceeds the maximum length when the IP packet is rebuilt with a destination host. An abnormal packet statistic information storing unit 129 stores the abnormal packet number detected by the signature unit. When the signature is hit at S2, the abnormal packet statistic information is added at S3.

The traffic analyzing device 700a regularly retrieves the traffic data collected by the Ingress packet filter statistic collecting unit 191, the abnormal traffic detection statistic collecting unit 192, and the Egress packet filter statistic collecting unit 193 of the management unit 190 of the traffic collecting device 100 at a second/minute interval, and creates a process, a monitor, a real time table and graph (waveform), a report, and the like. The traffic analyzing device 700a recognizes format information, a method of collecting data, and the like, to perform a report and analysis based on the data collected by the traffic collecting device 100.

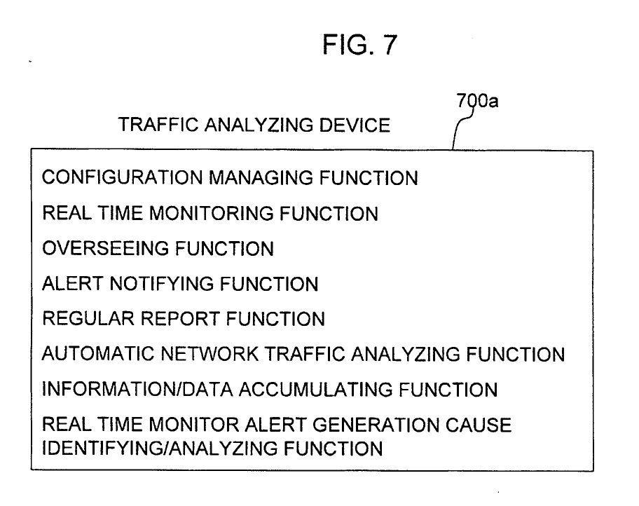

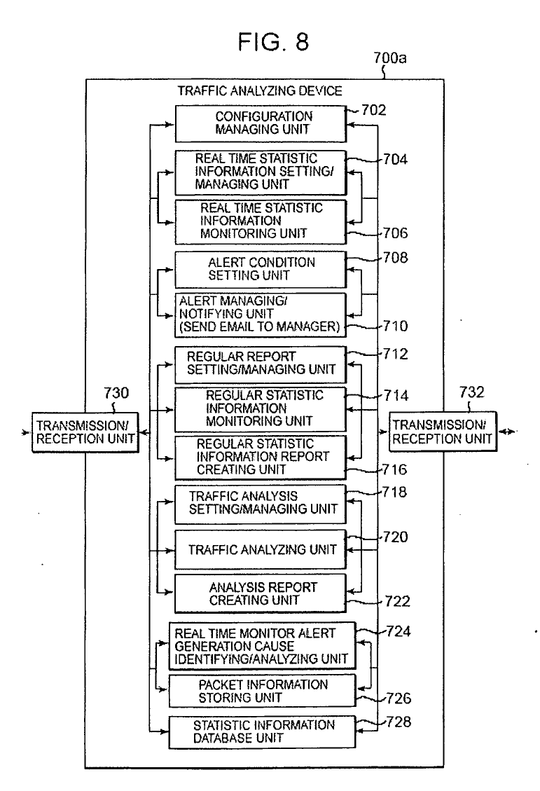

FIG. 7 is a schematic diagram illustrating functions of the traffic analyzing device 700a. FIG. 8 is a schematic diagram illustrating a configuration of the traffic analyzing device 700a for realizing the functions shown in FIG. 7. The traffic analyzing device 700a has a central processing unit (CPU). Each constituent element of the traffic analyzing device 700a can be realized by operating the CPU by software (computer program).

As shown in FIG. 7, the traffic analyzing device 700a has a configuration managing function, a real time monitoring function, an oversight function, an alert notifying function, a regular reporting function, an automatic network traffic analyzing function (network traffic analyzing function), an information/data accumulating function, and a real time monitor alert generation cause identifying/analyzing function.

As shown in FIG. 8, the traffic analyzing device 700a includes a configuration managing unit 702, a real time statistic information setting/managing unit 704, a real time statistic information monitoring unit 706 (as a real time monitoring unit), an alert condition setting unit 708, an alert managing/notifying unit 710, a regular report setting/managing unit 712, an regular statistic information monitoring unit 714, a regular statistic information report creating unit 716, a traffic analysis setting/managing unit 718, a traffic analyzing unit 720 (or network traffic analyzing unit), an analysis report creating unit 722, a real time monitor alert generation cause identifying/analyzing unit 724, a packet information storing unit 726, and a statistic information database unit 728. The traffic analyzing device 700a further includes a transmission/reception unit 730 that transmits and receives information to and from the traffic collecting device 100 or the monitoring device 600, and a transmission/reception unit 732 that transmits and receives information to and from the integrated management device 800 (see FIG. 1).

An alert generated in the traffic monitoring of the traffic analyzing device 700a, a cause identification analysis result report performed by the generation of an upper limit excess alert, an regular report generated on time, an analysis report, and the like are sent to the integrated management device 800 integrally managing the plurality of the traffic analyzing devices 700a, 700b, 700c.

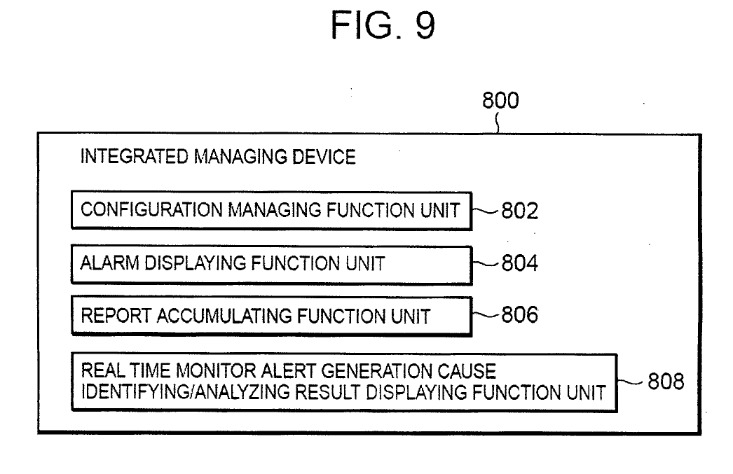

FIG. 9 is a schematic diagram illustrating a functional configuration of the integrated management device 800. The integrated management device 800 includes a configuration managing function unit 802, an alarm displaying function unit 804, a report accumulating function unit 806, and a real time monitor alert generation cause identifying/analyzing result displaying function unit 808. The integrated management device 800 integrally manages the plurality of traffic analyzing devices 700a-700c, and can refer to traffic data of each of the traffic analyzing devices 700a-700c.

The real time oversight function of the traffic analyzing device 700a is realized in the real time statistic information setting/managing unit 704 and the real time statistic information monitoring unit 706.

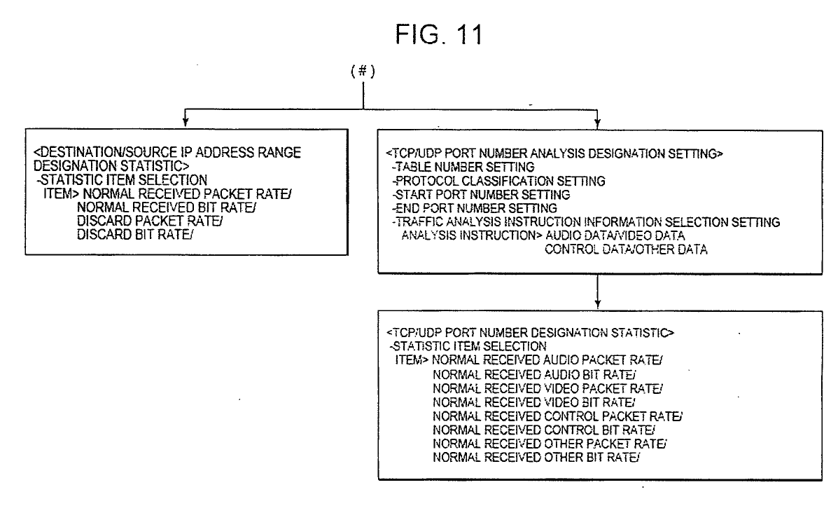

FIG. 10 and FIG. 11 are schematic diagrams illustrating a configuration of the real time statistic information setting/managing unit 704. The real time statistic information setting/managing unit 704 manages settings of the monitored information when information is collected in real time by the traffic analyzing device 700a. As shown in FIG. 10, the real time statistic information setting/managing unit 704 manages a monitor basic setting and a monitor item setting. As the monitor item setting, there are an Ingress/Egress monitor setting and an abnormal traffic monitor setting. As the Ingress/Egress monitor setting, there are a total received packet basic statistic setting and a policy rule statistic setting. As shown in FIG. 11, as the policy rule statistic setting, there are a setting of selecting an item of destination/source IP address range designation statistic(s) and a TCP/UDP port number analysis designation setting. As the TCP/UDP port number analysis designation, there is a setting of selecting an item of TCP/UDP port number designation statistics.

As shown in FIG. 10, in “abnormal traffic monitor setting,” it is possible to select and set a statistic target of a signature abnormality, a session abnormality, a simultaneous session number excess abnormality, a second-interval session number excess abnormality, and a total abnormal packet number. When “abnormal packet information storing setting” is valid with respect to these abnormalities, header information of the abnormal packet or the like is extracted before the packet is discarded as shown in the flow diagram of FIG. 6. The information is stored in each abnormal DB of the abnormal packet information storing unit 130 as shown in FIG. 5.

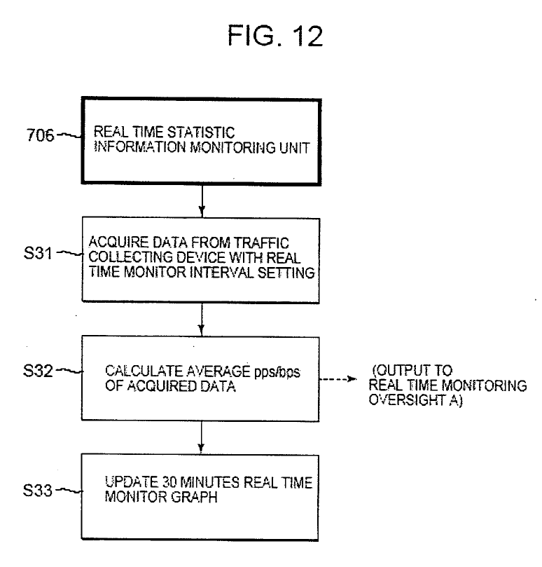

FIG. 12 is a schematic diagram illustrating the processes of the real time statistic information monitoring unit 706. The real time statistic information monitoring unit 706 gets (acquires) the data collected from the traffic collecting device 100 at a time interval set with a real time monitor interval setting, based on the setting conditions of the real time statistic information setting/managing unit 704 (S31). Then, an average value pps/bps of the acquired data is calculated (S32), and the display of the 30 minutes real time monitoring graph is updated (S33). The average value pps/bps calculated at S32 is output to a real time monitoring oversight A.

The monitoring function and the alert notifying function of the traffic analyzing device 700a are realized by coordination of the real time statistic information monitoring unit 706, the alert condition setting unit 708, and the alert managing/notifying unit 710.

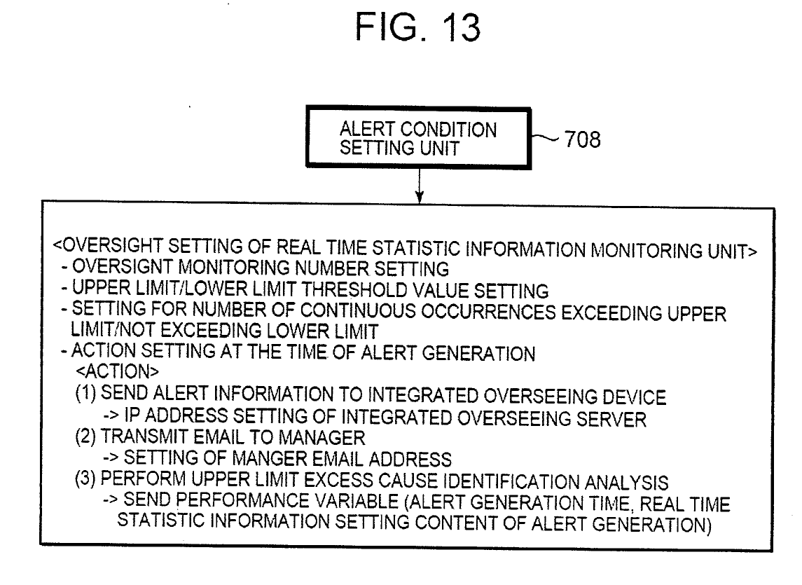

FIG. 13 is a schematic diagram illustrating settings performed in the alert condition setting unit 708. As shown in FIG. 13, in the alert condition setting unit 708, a monitoring setting of the real time statistic information monitoring unit is primarily performed. When an alert is generated, alert information is sent to the integrated management device 800 and an email is sent to a manager at, for example, manager terminal 900 (FIG. 1), thereby performing an action setting such as upper limit excess cause identification and analysis.

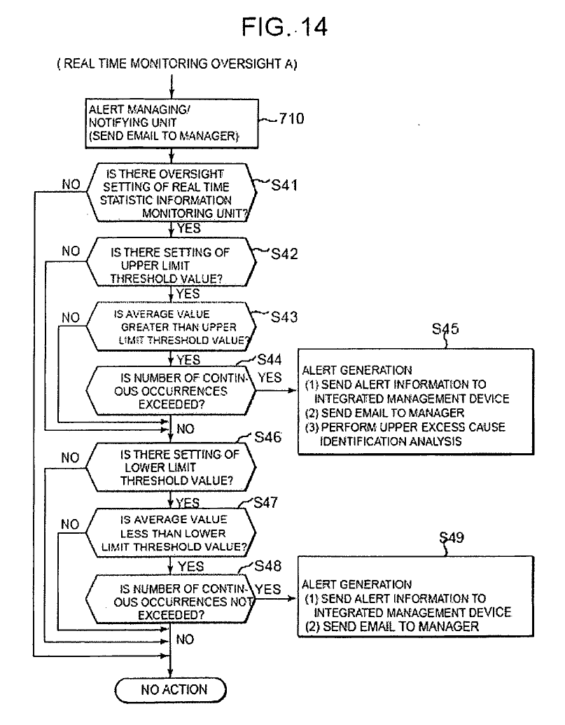

FIG. 14 is a flow diagram illustrating the processes of the alert managing/notifying unit 710 shown in FIG. 8, with the illustrated real time monitoring oversight A being one of the functions of the traffic analyzing device 700a of FIG. 8. The alert managing/notifying unit 710 monitors the average value pps/bps output to a real time monitoring oversight A according to the setting conditions of the alert condition setting unit 708, and generates an alert based on the conditions. First, at S41, it is determined whether or not there is an oversight setting of the real time statistic information monitoring unit. When there is the oversight setting, the process proceeds to S42. At S42, it is determined whether or not there is a setting of an upper limit threshold value. When there is an upper limit threshold value, it is determined whether or not the average value pps/bps is greater than the upper limit threshold value at S43.

When the average value is greater than the upper limit threshold value at S43, the process proceeds to S44 and it is determined whether or not the average value pps/bps exceeds the number of continuous occurrences (or continuous generation times). When the number of continuous occurrences is exceeded, the process proceeds to S45 and an alert is generated. Specifically, according to the setting conditions of the alert condition setting unit 708, alert information is sent to the integrated management device 800, an email is sent to a manager, and performance variables (alert generation time, real time statistic information setting content of alert generation) are sent to the real time monitor alert generation cause identifying/analyzing unit, thereby performing a process such as upper limit excess cause identification and analysis.

When there is no setting of the upper limit threshold value at S42, when the upper limit threshold value is not exceeded at S43, or when the number of continuous occurrences is not exceeded at S44, the process proceeds to S46. At S46, it is determined whether or not there is a setting of a lower limit threshold value. When the lower limit threshold value is set, the process proceeds to S47.

At S47, it is determined whether or not the average value pps/bps is less than a lower limit threshold value (not exceed the lower limit threshold value). When the average value pps/bps does not exceed the lower limit threshold value, the process proceeds to S48 and it is determined whether or not the number of continuous occurrences is exceeded. When the number of continuous occurrences is exceeded, the process proceeds to S49 and an alert is generated. Specifically, alert information is sent to the integrated management device 800, or an email is sent to a manager.

When there is no monitoring setting at S41, when the lower limit threshold value is not set at S46, the lower limit threshold value is not exceeded at S47, or when the number of continuous occurrences is not exceeded at S48, no action is generated. As described above, the alert managing/notifying unit 710 can generate an alert based on the settings of the alert condition setting unit 708 by comparison of the average value pps/bps.

The regular reporting function of the traffic analyzing device 700a is realized by the regular report setting/managing unit 712, the regular statistic information monitoring unit 714, and the regular statistic information report creating unit 716 shown in FIG. 8.

The real time monitor alert generation cause identifying/analyzing function of the traffic analyzing device 700a is realized by the real time monitoring function and the real time monitor alert generation cause identifying/analyzing unit 724 shown in FIG. 8.

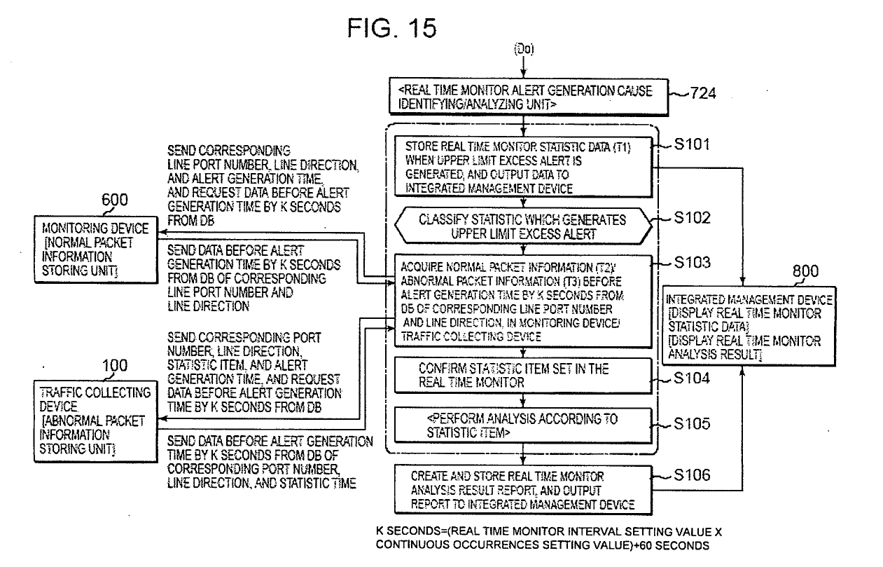

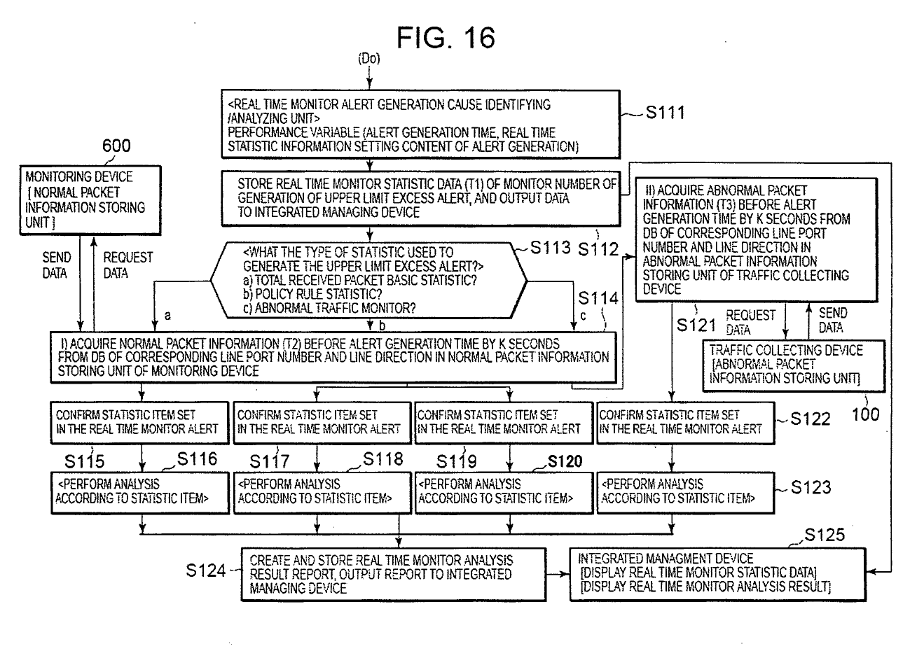

Even in the traffic monitoring, the traffic analyzing device 700a automatically performs the upper limit excess cause identification and analysis shown in FIG. 15 and FIG. 16, when the upper limit excess alert shown in FIG. 13 and FIG. 14 is generated in the real time statistic information shown in FIG. 10 and FIG. 11. The traffic analyzing device 700a classifies the statistics by performance variables (alert generation time, real time statistic information setting content of alert generation) at that time. In the monitoring device 600 and the traffic collecting device 100, normal packet information (T2)/abnormal packet information (T3) before the alert generation time by K seconds of (K seconds=(real time monitor interval setting value in FIG. 12×continuous occurrences setting value in FIG. 13)+60 seconds) is acquired from the DB of the corresponding line port number and line direction. The information is stored in the packet information storing unit 726. As shown in FIG. 15, the information is analyzed according to the statistic item where the real time monitor alert is set.

Hereinafter, the processes shown in FIG. 15 will be described. FIG. 15 shows the processes performed in the real time monitor alert generation cause identifying/analyzing unit 724, and shows the process of the analysis identifying the upper limit excess cause. In the real time monitor alert generation cause identifying/analyzing unit 724, an alert generation time, a monitor number; a line port number, a line direction, a statistic kind, and a statistic item are identified from the sent performance variables (alert generation time, real time statistic information setting content of alert generation). The real time monitor alert generation cause identifying/analyzing unit 724 acquires and analyzes the normal packet information from the monitoring device 600 and the abnormal packet information from the traffic collecting device 100 based on the information, and identifies a terminal, a subnet, and an application, or more generally a network entity, in which a problem occurs.

At S101, the real time monitor statistic data (T1) at the time of generating an upper limit excess alert is stored and then is output to the integrated management device 800. At S102, the statistic types of the generation of the upper limit excess alert are classified.

At S103, in the monitoring device 600 and the traffic collecting device 100, the normal packet information (T2) and the abnormal packet information (T3) before the alert generation time by K seconds are acquired from the database of the corresponding line port number and line direction.

At S103, the corresponding line port number, line direction, and alert generation time are sent to the monitoring device 600 to request the data before the alert generation time by K seconds from the database of the normal packet information storing unit 608 of the monitoring device 600. Receiving the request, the monitoring device 600 sends the normal packet information before the alert generation time by K seconds from the database of the corresponding line port number and line direction to the real time monitor alert generation cause identifying/analyzing unit 724 of the traffic analyzing device 700a.

At S103, the corresponding line port number, line direction, statistic item, and alert generation time are sent to the traffic collecting device 100 to request the data before the alert generation time by K seconds from the database of the abnormal packet information storing unit 130 of the traffic collecting device 100. Receiving the request, the traffic collecting device 100 sends the data before the alert generation time by K seconds from the database of the abnormal packet information storing unit 130 of the corresponding line port number, line direction, and statistic item.

At S104, statistic item set in the real time monitor alert is confirmed. At S105, analysis according to the statistic item is performed. Specifically, at S105, the following processes are performed.

A terminal, a subnet, and an application having the largest bandwidth usage are identified.

A terminal outputting the most multicast and broadcast packet rate is identified.

A terminal and an application outputting the largest number of signature abnormalities and session abnormalities are identified.

A terminal and an application using the largest number of sessions are identified.

At S106, a real time monitor analysis result report is created and stored, and the report is output to the integrated management device 800. The integrated management device 800 displays the real time monitor statistic data, and displays the real time monitor analysis result.

FIG. 16 is a schematic diagram illustrating the processes shown in FIG. 15 in more detail. Hereinafter, the processes performed by the real time monitor alert generation cause identifying/analyzing unit 724 will be described in detail with reference to FIG. 16. At S111, performance variables (alert generation time, real time statistic information setting content of alert generation) are acquired.

At S112, the real time monitor statistic data (T1) of the monitor number causing the upper limit excess alert is stored and is output to the integrated management device 800. At S113, the statistic type of the generation of the upper limit excess alert is determined as a: a) total received packet basic statistic; b) policy rule statistic; or c) abnormal traffic monitor. When the type of the statistic used to generate the upper limit excess alert is a) total received packet basic statistic, the process proceeds to S15 after S114. When the type of the statistic used to generate the upper limit excess alert is b) policy rule statistic, the process proceeds to S117 after S114, or S119. When the type of the statistic used to generate the upper limit excess alert is c) abnormal traffic monitor, the process proceeds to S121 after S114.

At S114, the normal packet information (T2) before the alert generation time by K seconds is acquired from the database of the corresponding line port number and line direction of the normal packet information storing unit 608 of the monitoring device 600.

When the type of the statistic used to generate the upper limit excess alert is a) total received packet basic statistic, the process proceeds to S115. At S115, confirm statistic item set in the real time monitor alert. In this case, the statistic items of a normal received packet rate, a normal received bit rate, a normal received multicast packet rate, and a normal received broadcast packet rate are confirmed as the basic statistic of the total received packet.

At S116, analysis according to the statistic item of S115 is performed. With respect to the normal received packet rate and the normal received bit rate, statistics of uni-cast packet rate/bit rate are collected for each TCP/UDP port and for each source IP on the data T2 (normal packet information) acquired at S114. Three terminals having the largest bandwidth usage and three applications having the largest bandwidth usage are identified. With respect to the normal received multicast packet rate, statistics of the multicast packet rate are collected for each IP sender (address) on the data T2, and three terminals outputting the most multicast packets are identified. With respect to the normal received broadcast packet rate, statistics of the broadcast packet rate are collected for each source IP on the data T2, and three terminals outputting the most broadcast packets are identified.

When the type of the statistic used to generate the upper limit excess alert is b) policy rule statistic, the process proceeds to S117 or S119. At S117, confirm statistic item set in the real time monitor alert. In this case, the statistic items of a normal received packet rate and a normal received bit rate are confirmed as a designation statistic of a source IP address range (subnet).

At S118, analysis according to the statistic item of S117 is performed. With respect to the normal received packet rate and the normal received bit rate, statistics of the received packet rate/normal received bit rate are collected for each IP sender (address) on the data T2, and statistics are collected further for each subnet. Accordingly, three subnets having the largest bandwidth usage are identified.

At S119, statistic item set in the real time monitor alert is confirmed. In this case, a table number setting, a protocol classification setting, a start port number setting, and an end port number setting are confirmed as a TCP/UDP port number analysis designation setting. Audio data, video data, control data, and the other data are confirmed as a traffic analysis instruction and an information selection setting analysis instruction.

At S120, analysis according to the statistic item of S119 is performed. In this case, statistics of the received bit rate are collected for each TCP/UDP port number on the data T2, and statistics are collected further for each port number designation range. Accordingly, three applications having the largest band using amount are identified.

When the type of the statistic used to generate the upper limit excess alert is c) abnormal traffic monitor, the process proceeds to S121. At S121, the abnormal packet information (T3) before the alert generation time by K seconds is acquired from each database of the corresponding line port number and line direction of the abnormal packet information storing unit 130 of the traffic collecting device 100.

At S122, statistic item set in the real time monitor alert is confirmed. In this case, with respect to the abnormal traffic monitor, the statistic item is confirmed for each item of a signature abnormality, a session abnormality, a simultaneous session excess abnormality, and a second-interval session excess abnormality.

At S123, analysis according to the statistic item is performed for each item confirmed at S122. First, with respect to the signature abnormality, statistics of the signature abnormality are collected for each source IP and for each TCP/UDP port on the data T3 (abnormal packet information T3) acquired from the signature abnormal database 132, and three terminals and three applications outputting the largest number of abnormalities are identified. With respect to the session abnormality, statistics of the session abnormality are collected for each source IP and for each TCP/UDP port number on the data T3 acquired from the session abnormal data base 134, and three terminals and three applications outputting the largest numbers of abnormalities are identified. With respect to the simultaneous session abnormality, the data T3 acquired from the simultaneous session number excess abnormal database 136 is added to the data T2, and statistics of the session number are collected for each source IP and for each TCP/UDP poll number in units of minutes. Accordingly, three terminals and three applications having the largest number of sessions used are identified. With respect to the second-interval session number excess abnormality, the data T3 acquired from the second-interval session number excess abnormal database 138 is added to the data T2, and statistics of the session number are collected for each source IP and for each TCP/UDP port number by the second unit. Accordingly, three terminals and three applications having the largest number of sessions used are identified.

After S116, S118, S120 and S123, the process proceeds to S124, and a real time monitor analysis result report is created and output to the integrated management device 800. At S125, the integrated management device 800 displays the real time monitor statistic data and the real time monitor analysis result.

As described above, it is possible to identify the cause of the upper limit excess problem as follows by analysis. Then, a report of the analysis result is created, stored, and output to the integrated management device 800. It is possible to identify three terminals, three subnets, and three applications having the largest bandwidth usage.

It is possible to identify three terminals outputting the most multicast packets and broadcast packet rate.

It is possible to identify three terminals and three applications outputting the largest number of signature abnormalities and session abnormalities.

It is possible to identify three terminals and three applications using the largest number of sessions.

According to the above exemplary embodiment, it is possible to monitor abnormal traffic and normal traffic in real time. Therefore, when an upper limit value excess alert is generated, it is possible to automatically perform the real time monitor alert generation cause identifying/analyzing function.

When the real time monitor alert generation cause identifying/managing function is performed, it is possible to acquire the normal packet information (T2) and the abnormal packet information (T3) just before the alert generation time from the DB of the corresponding line port number and line direction, by classifying the statistics by the performance variables (alert generation time, real time statistic information setting content of alert generation). It is possible to identify and analyze the cause according to the set statistic items by acquiring the packet information. In addition, it is possible to create and store the report of the analysis result, and it is possible to output the report to the integrated management device 800.

The preferred embodiment of the invention has been described above with reference to the accompanying drawings, but the invention is not limited to the embodiment. It is clear that a person skilled in the art can change or modify the invention within the scope described in the claims, and it is understood that the changed or modified embodiment falls within the technical scope of the invention.

What is claimed is:

1. A network traffic analyzing device for analyzing traffic comprising:
a real time monitoring unit configured to collect information regarding communication data between a primary network and an access network from a traffic collecting device in real time;
an alert managing/notifying unit configured to generate an alert regarding traffic between the primary network and the access network based on the information collected in real time by the traffic collecting device; and
an alert generation cause analyzing unit configured to analyze a cause of the alert generated by the alert managing/notifying unit based on information regarding at least one of normal data and abnormal data transmitted and received between the primary network and the access network prior to generation of the alert by the alert managing/notifying unit.

2. The network traffic analyzing device according to claim 1, wherein the alert generation cause analyzing unit analyzes the cause of the alert generation for each statistic item where the alert is set by real time monitoring.

3. The network traffic analyzing device according to claim 1, wherein the alert generation cause analyzing unit collects statistics of a terminal or an application that causes an abnormality based on the information regarding the abnormal data, to identify at least one of a terminal, a subnet, and an application having a large number of abnormalities.

4. The network traffic analyzing device according to claim 1, wherein the alert generation cause analyzing unit collects statistics of a number of sessions based on the information regarding the normal data and the information regarding the abnormal data, to identify at least one of a terminal, a subnet, and an application having a large number of sessions.

5. The network traffic analyzing device according to claim 1, wherein the alert generation cause analyzing unit is configured to acquire the information regarding the at least one of normal data and abnormal data a predetermined time before the alert managing/notifying unit generates the alert.

6. The network traffic analyzing device according to claim 1, further comprising an alert condition setting unit configured to perform a monitoring setting of the real time monitoring unit by setting at least one of an upper limit threshold value and a lower limit threshold value for one of packets per second and bits per second.

7. The network traffic analyzing device according to claim 1, further comprising a real time statistic information setting/managing unit configured to manage settings of the information collected in real time by the traffic collecting device, the settings including a monitor basic setting and a monitor item setting.

8. The network traffic analyzing device according to claim 1, wherein the real time monitoring unit is configured to extract and store normal packet information regarding the communication data.

9. The network traffic analyzing device according to claim 2, wherein the alert generation cause analyzing unit is configured to acquire the at least one of normal packet data and abnormal packet data prior to the generation of the alert by the alert managing/notifying unit from a database of a corresponding line port number and a line direction in the traffic collecting device.

10. The network traffic analyzing device according to claim 2, wherein the alert managing/notifying unit is configured to generate an upper limit excess alert when an average value of one of packets per second and bits per second exceeds an upper limit threshold value, and the statistic item of the upper limit excess alert is determined as one of total received packet basic statistic, policy rule statistic, and abnormal traffic monitor.

11. A method of analyzing network traffic comprising:
collecting information regarding communication data between a primary network and an access network from a traffic collecting device in real time;
generating an alert regarding traffic between the primary network and the access network based on the information collected in real time from the traffic collecting device; and
analyzing a cause of the alert generation based on information on at least one of normal data and abnormal data transmitted and received between the primary network and the access network just before the alert is generated.

12. The method of claim 11, wherein the analyzing a cause of the alert generation comprises collecting statistics of at least one of a terminal and an application that causes an abnormality based on the information regarding the abnormal data, to identify a network entity having a large number of abnormalities.

13. The method of claim 11, wherein the analyzing a cause of the alert generation comprises collecting statistics of a number of sessions based on the information regarding the normal data and the information regarding the abnormal data to identify at least one of a terminal, a subnet, and an application having a large number of sessions.

14. The method of claim 1, further comprising:
setting at least one of an upper limit threshold value and a lower limit threshold value for one of packets per second and bits per second to define an alert condition;
monitoring the information collected in real time to determine if the alert condition is reached; and
executing the generating of an alert if the alert condition is reached.

15. The method of claim 11, further comprising managing settings of the information collected in real time by the traffic collecting device, the settings including a monitor basic setting and a monitor item setting.

16. A network traffic analyzing system comprising:
a traffic collecting device for collecting information on abnormal traffic from an access network connected to a primary network;
a network traffic analyzing device for analyzing the collected traffic information; and
a monitoring device connected to the traffic collecting device for monitoring and storing information on normal traffic, wherein
the network traffic analyzing device includes:
a real time monitoring unit configured to collect information regarding communication data between the primary network and the access network in real time from the traffic collecting device;
an alert managing/notifying unit configured to generate an alert regarding traffic between the primary network and the access network based on the information collected in real time from the traffic collecting device; and
an alert generation cause analyzing unit configured to analyze the cause of the alert generation based on information regarding at least one of normal data and abnormal data transmitted and received between the primary network and the access network just before the alert is generated.

17. The network traffic analyzing system according to claim 16, wherein the monitoring device is configured to extract only packet header information from the normal traffic to minimize storage space requirements for the information on normal traffic.

18. The network traffic analyzing system according to claim 16, wherein the traffic collecting device includes a filter to extract and search packet header identifiers as the information on abnormal traffic, and to filter the information on abnormal traffic based on the packet header identifiers.

19. The network traffic analyzing system according to claim 18, wherein the filter is configured to include a packet filter table for assigning a priority to each of the extracted packet header identifiers and a counter for tracking a number of hits on each of the extracted packet header identifiers.

20. The network traffic analyzing system according to claim 16, wherein traffic collecting device includes the abnormal traffic detecting unit having an abnormal packet information storing unit.

21. The network traffic analyzing system according to claim 20, wherein
the abnormal packet information storing unit includes a plurality of databases including a signature abnormal database (DB), a session DB, a simultaneous session number excess abnormal DIB, and a second-interval session number excess abnormal DBI, and
time, ether header information, Internet Protocol (IP) header information, TCP/UDP header information, and payload size information are stored as information for abnormal packets therein.

22. The network traffic analyzing system according to claim 21, wherein
the traffic collecting device checks for existence of storing settings including a signature abnormality/a session abnormality/a simultaneous session number excess abnormality/a second-interval session number excess abnormality, and the traffic collecting device stores abnormal packet information in at least one of the plurality of databases in the abnormal packet information storing unit after confirming the existence of the storing settings and before discarding the abnormal packet information when storing settings exist.
